(19) United States
(12) Patent Application Publication
(10) Pub. No.: US 2025/0296291 A1
(43) Pub. Date: Sep. 25, 2025

(54) POROUS BODY AND SOUND ABSORBING MATERIAL

(71) Applicant: Murata Manufacturing Co., Ltd., Nagaokakyo-shi (JP)

(72) Inventor: Shunsuke OTOMO, Nagaokakyo-shi (JP)

(21) Appl. No.: 19/227,643

(22) Filed: Jun. 4, 2025

Related U.S. Application Data
(63) Continuation of application No. PCT/JP2023/042731, filed on Nov. 29, 2023.

(30) Foreign Application Priority Data
Dec. 19, 2022 (JP) 2022-202152

(51) Int. Cl. B32B 5/26; B32B 5/02

(52) U.S. Cl. CPC B32B 5/265; B32B 5/022; B32B 2250/03; B32B 2250/20; B32B 2262/0276; B32B 2305/55; B32B 2307/10; B32B 2307/72; B32B 2307/7376

(57) ABSTRACT

A porous body that includes a fibrous body layer having entangled liquid crystal polymer fibers, wherein the entangled liquid crystal polymer fibers have a fiber diameter of not less than 1 μm and not more than 3 μm, and the fibrous body layer has a fiber density of 100 kg/m³ or more.

### CROSS REFERENCE TO RELATED APPLICATIONS

The present application is a continuation of International application No. PCT/JP2023/042731, filed Nov. 29, 2023, which claims priority to Japanese Patent Application No. 2022-202152, filed Dec. 19, 2022, the entire contents of each of which are incorporated herein by reference.

### TECHNICAL FIELD

The present disclosure relates to a porous body and a sound absorbing material.

### BACKGROUND ART

Patent Document 1 discloses a multilayer article including a support layer and a submicron fiber layer on the support layer. The submicron fiber layer comprises polymer fibers having a median fiber diameter of less than 1 μm.

Patent Document 2 discloses a nonwoven fabric structure including a fibrous body formed of entangled fibers. The fibers comprise resin nanofibers having a fiber diameter of less than 1 μm. The fibrous body has a thickness of 10 mm or more and a fiber density of not less than 10 kg/m³ and less than 50 kg/m³.
Patent Document 1: Japanese Unexamined Patent Application Publication No. 2014-15042
Patent Document 2: Japanese Unexamined Patent Application Publication No. 2016-121426

### SUMMARY OF THE DISCLOSURE

The multilayer article described in Patent Document 1 and the nonwoven fabric structure described in Patent Document 2 can be used, for example, as a sound absorbing material. Porous materials, as typified by glass wool or urethane foam, have been widely used as sound absorbing materials. However, such porous materials have low sound absorption characteristics in the low-mid frequency range. In order for such a porous material to absorb sound especially in the low frequency range of not more than 1000 Hz, the material needs to have a large thickness. This poses a space-consuming problem.

While the multilayer article described in Patent Document 1 and the nonwoven fabric structure described in Patent Document 2 have improved sound absorption characteristics owing to the use of nanofibers, their sound absorption characteristics are still insufficient in the low frequency range; there is still room for improvement.

The present disclosure has been made to solve the above problems. It is therefore an object of the present disclosure to provide a porous body which can be used as a sound absorbing material or the like. It is also an object of the present disclosure to provide a sound absorbing material which, even when it is thin, has excellent sound absorption characteristics in the low frequency range.

The porous body of the present disclosure comprises a fibrous body layer comprising entangled liquid crystal polymer fibers, wherein the entangled liquid crystal polymer fibers have a fiber diameter of not less than 1 μm and not more than 3 μm and the fibrous body layer has a fiber density of 100 kg/m³ or more.

The sound absorbing material of the present disclosure comprises the porous body of the present disclosure.

The present disclosure makes it possible to provide a porous body which can be used as a sound absorbing material or the like. The present disclosure also makes it possible to provide a sound absorbing material which, even when it is thin, has excellent sound absorption characteristics in the low frequency range.

### BRIEF DESCRIPTION OF THE DRAWINGS

FIG. 1 is a cross-sectional view schematically showing an example of the porous body of the present disclosure.

FIG. 2 is a cross-sectional view schematically showing another example of the porous body of the present disclosure.

FIG. 3 is a cross-sectional view showing yet another example of the porous body of the present disclosure.

### DESCRIPTION OF THE PREFERRED EMBODIMENTS

The porous body of the present disclosure will now be described.

It is to be noted that the present disclosure is not limited to the features described below, and various changes and modifications may be made thereto within the spirit and scope of the present disclosure. Two or more preferred features of the present disclosure as described below may be combined; such a combined feature will fall within the scope of the present disclosure.

The uses of the porous body of the present disclosure are not particularly limited; it can be used, for example, as a sound absorbing material. A sound absorbing material comprising the porous body of the present disclosure constitutes one aspect of the present disclosure.

In one embodiment, the porous body of the present disclosure can be used in such a manner that it is fixed to a wall surface using an adhesive on one side of the porous body. For example, the porous body can be directly attached to a cover for an automobile or to an inner surface of a housing of an electrical appliance. A space (air layer) may be provided behind the porous body fixed on a surface so that when it is used as a sound absorbing material, more effective sound absorption characteristics can be achieved.

The following drawings are schematic; thus, dimensions, aspect ratios, etc. may not to scale. In the drawings, the same reference signs are used for the same or equivalent portions. Further, in the drawings, the same elements or components are given the same reference signs, and a duplicate description thereof will be omitted.

Terms indicating a relationship between elements or components (such as “perpendicular”, “parallel”, and “orthogonal”) and terms indicating the shape of an element or component, as used herein, should be construed not in a strict sense but in a broad sense that includes a range of substantial equivalence, for example, a difference on the order of a few percent.

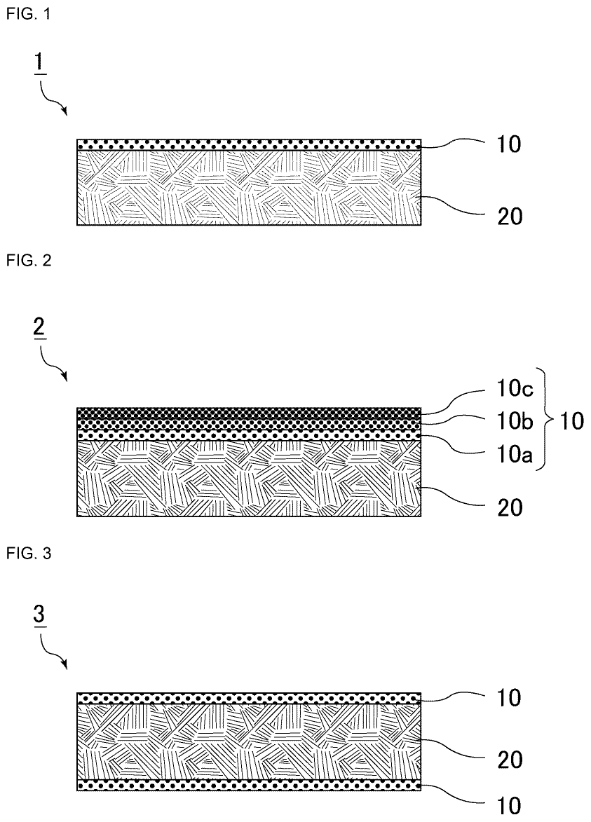

FIG. 1 is a cross-sectional view schematically showing an example of the porous body of the present disclosure.

The porous body 1 shown in FIG. 1 includes a fibrous body layer 10. As shown in FIG. 1, the porous body 1 preferably further includes a support layer 20. In the porous body 1 shown in FIG. 1, the fibrous body layer 10 is provided on one main surface of the support layer 20. On the other hand, no fibrous body layer 10 is provided on the other main surface of the support layer 20.

The fibrous body layer 10 is formed of entangled liquid crystal polymer (LCP) fibers. When, for example, the porous body 1 is used as a sound absorbing material, the high vibration damping properties of the liquid crystal polymer fibers can improve the sound absorption characteristics especially in the low frequency range.

The liquid crystal polymer fibers are preferably a nanofiber liquid crystal polymer (hereinafter also referred to as LCP-NF).

The LCP-NF includes, for example, a fiber portion and a lump portion. The fiber portion may be contained as an aggregate portion, which is an aggregate of fibrous particles, in the LCP-NF. The lump portion may be contained as an aggregate portion, which is an aggregate of lump particles, in the LCP-NF. The LCP-NF need not necessarily include a lump portion.

The fiber portion comprises fibrous particles. The fibrous particles are, for example, liquid crystal polymer particles having an aspect ratio, which is the ratio of the longitudinal length to the fiber diameter, of 10 or more. The longitudinal length and fiber diameter of a fibrous particle can be determined from image data of the fibrous particle, obtained upon observation of the fibrous particle with a scanning electron microscope.

The lump portion is a substantially non-fibrous portion of the LCP-NF. The lump portion may have a flattened shape. The content of the lump portion in the LCP-NF is, for example, 20% or less. Thus, it is preferred that the content of the lump portion in the LCP-NF be relatively low; the content of the lump portion may be zero. The content of the lump portion can be evaluated as the ratio of the number of the lump portions to the number of the aggregate portions in the LCP-NF.

The liquid crystal polymer fibers, such as the LCP-NF, are preferably made of a thermotropic liquid crystal polymer which exhibits liquid crystallinity when it is in a molten state.

Among thermotropic liquid crystal polymers, there is a thermotropic liquid crystal polyester (hereinafter simply referred to as “liquid crystal polyester”), such as an aromatic polyester which is obtained by reacting an aromatic hydroxycarboxylic acid as an essential monomer with a monomer such as an aromatic dicarboxylic acid or an aromatic diol, and which exhibits liquid crystallinity when it is in a molten state. Representative examples include type I liquid crystal polyester synthesized from parahydroxybenzoic acid (PHB), phthalic acid, and 4,4′-biphenol, type II liquid crystal polyester synthesized from PHB and 2,6-hydroxynaphthoic acid, and type III liquid crystal polyester synthesized from PHB, terephthalic acid, and ethylene glycol.

Among them, type I liquid crystal polyester or type II liquid crystal polyester is preferred because it has superior heat resistance and hydrolysis resistance. In type I liquid crystal polyester, isophthalic acid is preferred as the phthalic acid.

The fiber diameter of the liquid crystal polymer fibers in the fibrous body layer 10 is not less than 1 μm and not more than 3 μm.

The fiber diameter of the liquid crystal polymer fibers in the fibrous body layer 10 can be measured by observation of a magnified image of the fibrous body layer 10.

The fiber density of the fibrous body layer 10 is 100 kg/m³ or more.

The fiber density of the fibrous body layer 10 can be determined by dividing the basis weight of the fibrous body layer 10 by the thickness. The basis weight is the weight of fibers per unit area of the fibrous body layer 10. The basis weight can be determined, for example, by calculating the weight per unit area from the weight of the fibrous body layer 10.

Patent Documents 1 and 2, which are prior-art documents, describe examples of sound absorbing materials using nanofibers made of a material having a low loss coefficient. However, in order to improve the sound absorption coefficient of such a sound absorbing material e.g. in the low frequency band of not more than 1000 Hz, the thickness of the material needs to be made greater than 10 mm, making it difficult to take noise countermeasures in the low frequency band for an article, such as an automobile, where the installation space for a sound absorbing material is limited.

In contrast, by making the fiber diameter of the liquid crystal polymer fibers in the fibrous body layer 10 not less than 1 μm and not more than 3 μm, and making the fiber density of the fibrous body layer 10 100 kg/m³ or more as in the porous body 1, it becomes possible to improve the sound absorption characteristics in the low frequency range even when the porous body is thin.

Further, by making the fiber diameter of the liquid crystal polymer fibers in the fibrous body layer 10 not less than 1 μm and not more than 3 μm, and making the fiber density of the fibrous body layer 10 100 kg/m³ or more as in the porous body 1, the mechanical strength of the fibrous body layer 10 can be increased, making it possible to prevent collapse of the layer due to compression during use.

While the upper limit of the fiber density of the fibrous body layer 10 is not particularly limited, the fiber density is preferably 1000 kg/m³ or less, more preferably 500 kg/m³ or less. When the porous body 1 is used as a sound absorbing material, if the fiber density of the fibrous body layer 10 is too high, and the porosity is too low, there will be a large mismatch with the acoustic impedance of air. Accordingly, sound waves are likely to be reflected by the surface of the material, and thus the sound absorption coefficient is likely to be low.

The fibrous body layer 10 preferably has an average pore diameter of 4 μm or less. When, for example, the porous body 1 is used as a sound absorbing material, control of the pore diameter of the fibrous body layer 10 makes it possible to control, through the change of its air permeability, the sound absorption characteristics of the sound absorbing material in the low frequency range.

From the viewpoint of controlling the sound absorption characteristics in the low frequency range, the average pore diameter of the fibrous body layer 10 is preferably 0.5 μm or more, more preferably 1 μm or more, and even more preferably 1.5 μm or more. When the porous body 1 is used as a sound absorbing material, if the average pore diameter of the fibrous body layer 10 is too small, the flow resistance per unit thickness will be too high, resulting in a large mismatch with the acoustic impedance of air. Accordingly, sound waves are likely to be reflected by the surface of the material, and thus the sound absorption coefficient is likely to be low.

The average pore diameter of the fibrous body layer 10 can be measured using a mercury porosimeter. In the examples described below, the average pore diameter is determined by measuring a pore distribution using a mercury intrusion porosimeter (manufactured by Micromeritics Instrument Corporation, AutoPore V 9605).

As shown in FIG. 1, the fibrous body layer 10 is preferably supported by the support layer 20. The inclusion of the support layer 20 in the porous body 1 can increase the mechanical strength of the porous body 1 and, in addition, can maintain the shape of the porous body 1. Further, the porous body 1, composed of the fibrous body layer 10 and the support layer 20, can advantageously be used as a sound absorbing material: By reducing the fiber density or average pore diameter of the support layer 20, the porous body 1 will have the vibration damping effect of the fibrous body layer 10 while suppressing reflection of sound waves throughout the porous body 1, leading to an improvement in the sound absorption characteristics in the entire low frequency band.

The support layer 20 is formed of entangled fibers. While the type of the fibers constituting the support layer 20 is not particularly limited, the support layer 20 is preferably formed of entangled polyester fibers such as polyethylene terephthalate (PET) fibers.

In an area around the interface between the support layer 20 and the fibrous body layer 10, some of the fibers constituting the support layer 20 may be entangled with some of the liquid crystal polymer fibers constituting the fibrous body layer 10.

While the fiber diameter of the fibers in the support layer 20 is not particularly limited, it is preferably larger than the fiber diameter of the liquid crystal polymer fibers in the fibrous body layer 10.

While the fiber density of the support layer 20 is not particularly limited, it is preferably lower than the fiber density of the fibrous body layer 10.

While the average pore diameter of the support layer 20 is not particularly limited, it is preferably larger than the average pore diameter of the fibrous body layer 10.

FIG. 2 is a cross-sectional view schematically showing another example of the porous body of the present disclosure.

In the porous body 2 shown in FIG. 2, three fibrous body layers 10 (10a, 10b, and 10c) are provided on one main surface of the support layer 20. As in this example, two or more fibrous body layers 10 may be provided on one main surface of the support layer 20. When the porous body 2 is used as a sound absorbing material, the use of two or more fibrous body layers 10, through adjustment of the fiber density or the average pore diameter, will suppress the reflection of sound waves in the fibrous body layers 10, leading to an improvement in the sound absorption characteristics in the low frequency band.

When two or more fibrous body layers 10 are provided on one main surface of the support layer 20, the fibrous body layers 10 (e.g., fibrous body layers 10a, 10b, and 10c) may have the same or different fiber diameter(s) and/or fiber density(ies). At least one of the fibrous body layers 10 has a fiber diameter of not less than 1 μm and not more than 3 μm and a fiber density of 100 kg/m³ or more. Preferably, all the fibrous body layers 10 have a fiber diameter of not less than 1 μm and not more than 3 μm and a fiber density of 100 kg/m³ or more.

When two or more fibrous body layers 10 are provided on one main surface of the support layer 20, the thicknesses of all the fibrous body layers 10 may be the same, or the thicknesses of some or all of the fibrous body layers 10 may be different. The average pore diameters of all the fibrous body layers 10 may be the same, or the average pore diameters of some or all of the fibrous body layers 10 may be different.

FIG. 3 is a cross-sectional view showing yet another example of the porous body of the present disclosure.

In the porous body 3 shown in FIG. 3, a fibrous body layer 10 is provided on each of both main surfaces of the support layer 20. The porous body 3, having the structure in which the support layer 20 is sandwiched between the fibrous body layers 10, can advantageously be used as a sound absorbing material: When the fiber density or average pore diameter of the support layer 20 is smaller than that of the fibrous body layers 10, the effect of each fibrous body layer 10 will be multiplied, leading to an improvement in the sound absorption characteristics in the entire low frequency band. Further, compared to a structure in which a fibrous body layer(s) 10 is superimposed only on one main surface of the support layer 20, the thickness of a fibrous body layer 10 per one main surface of the support layer 20 can be made smaller so that sound waves will be more likely to pass through each fibrous body layer 10 and reflection of sound waves will be less likely to occur.

When a fibrous body layer 10 is provided on each of both main surfaces of the support layer 20, the fibrous body layers 10 may have the same or different fiber diameter(s) and/or fiber density(ies). A fibrous body layer(s) 10 provided on at least one of both main surfaces has a fiber diameter of not less than 1 μm and not more than 3 μm and a fiber density of 100 kg/m³ or more. Preferably, the fibrous body layers 10 provided on both main surfaces have a fiber diameter of not less than 1 μm and not more than 3 μm and a fiber density of 100 kg/m³ or more.

When a fibrous body layer 10 is provided on each of both main surfaces of the support layer 20, the thicknesses of the fibrous body layers 10 provided on the main surfaces may be the same or different. The average pore diameters of the fibrous body layers 10 provided on the main surfaces may be the same or different.

When a fibrous body layer(s) 10 is provided on each of both main surfaces of the support layer 20, two or more fibrous body layers 10 may be provided on one main surface of the support layer 20, and two or more fibrous body layers 10 may be provided on the other main surface of the support layer 20. In that case, the number of the fibrous body layers 10 provided on one main surface of the support layer 20 may be the same as or different from the number of the fibrous body layers 10 provided on the other main surface of the support layer 20.

The support layer 20 may consist of a single layer or two or more layers. When the support layer 20 consists of two or more layers, the fibers constituting the layers of the support layer 20 may be the same or different.

The porous body 1 may include a layer(s) other than the fibrous body layer(s) 10 and the support layer 20. In that case, the fibrous body layer(s) 10 is preferably disposed as the outermost layer(s) of the porous body 1. Thus, in the porous body of the present disclosure, a fibrous body layer(s), formed of entangled liquid crystal polymer fibers and having a fiber diameter of not less than 1 μm and not more than 3 μm and a fiber density of 100 kg/m³ or more, is preferably disposed as the outermost layer(s) of the porous body.

In the porous body of the present disclosure, the overall thickness is preferably less than 10 mm from the viewpoint of size reduction. When the porous body of the present disclosure is used as a sound absorbing material, the sound absorption characteristics can be improved without increasing the overall thickness. On the other hand, the overall thickness may preferably be 1 mm or more. If the porous body is too thin, it is more likely to reflect sound waves and less likely to adsorb low-frequency waves.

The thickness of the porous body is measured in an appropriate portion depending on the shape of the porous body. For example, when the porous body has a sheet-like shape, the thickness may be an average thickness of a flat portion of the porous body. When the shape of the porous body includes irregularities, the thickness may be an average thickness of a portion corresponding to a deepest recess(es) (i.e. a portion where the thickness of the porous body is the smallest) or, when the area occupancy of the deepest recess(es) in the planar direction is low (e.g., less than 50%), may be a value obtained by averaging out the level differences in the surface shape of the porous body.

The fibrous body layer constituting the porous body of the present disclosure has a structure having continuous fine pores. When the porous body of the present disclosure includes a support layer, the support layer also has a structure having continuous fine pores. Accordingly, the porous body of the present disclosure is both air-permeable and liquid-permeable. Therefore, the porous body of the present disclosure can be used, for example, both in an application that requires particular sound absorption characteristics and in an application that requires such sound absorption characteristics and some other function.

The porous body of the present disclosure can also be used in an application that solely requires such other function. From this perspective, the porous body of the present disclosure can advantageously be used as a constituent member of a nonwoven fabric product such as a sound absorbing material, a sound insulating material, a filtering material, an insulating separator, or an air filter.

The present specification discloses the following:
<1> A porous body comprising a fibrous body layer comprising entangled liquid crystal polymer fibers, wherein the entangled liquid crystal polymer fibers have a fiber diameter of not less than 1 μm and not more than 3 μm and the fibrous body layer has a fiber density of 100 kg/m³ or more.
<2> The porous body according to <1>, wherein an average pore diameter of the fibrous body layer is 4 μm or less.
<3> The porous body according to <2>, wherein the average pore diameter of the fibrous body layer is 0.5 μm or more.
<4> The porous body according to <2> or <3>, wherein the average pore diameter of the fibrous body layer is 1 μm or more.
<5> The porous body according to any one of <1> to <4>, further comprising a support layer comprising entangled fibers supporting the fibrous body layer.
<6> The porous body according to <5>, wherein the entangled fibers are entangled polyester fibers.
<7> The porous body according to <5> or <6>, wherein the fibrous body layer is on one main surface of the support layer.
<8> The porous body according to <5> or <6>, wherein the fibrous body layer is a first fibrous body layer and is on a first main surface of the support layer, the porous body further comprising a second fibrous body layer on a second main surface of the support layer.
<9> The porous body according to <7> or <8>, wherein the fibrous body layer comprises two or more layers, and is on at least one of both main surfaces of the support layer.
<10> The porous body according to any one of <1> to <9>, wherein the porous body has an overall thickness of less than 10 mm.
<11> A sound absorbing material comprising the porous body according to any one of <1> to <10>.

### EXAMPLES

The following examples more specifically disclose sound absorbing materials which are each an embodiment of the porous body of the present disclosure. It should be noted that the present disclosure is not limited to the examples.

### Example 1

Liquid crystal polymer (LCP) pellets were coarsely crushed using a cutter mill.

The coarsely crushed LCP was passed through a 3-mm mesh screen provided at the outlet of the cutter mill to obtain coarsely crushed LCP.

The coarsely crushed LCP was finely milled in a liquid nitrogen bead mill, and sieved through a 100-μm mesh screen to obtain finely milled LCP.

The finely milled LCP was dispersed in a 50 mass % aqueous ethanol solution and subjected to high-pressure dispersion treatment to obtain liquid crystal polymer fibers (fiber diameter 1 μm). In Example 1, the high-pressure dispersion treatment was performed five times at a pressure of 200 MPa.

The liquid crystal polymer fibers were added to 1,3-butanediol to obtain a paste.

The paste was applied to a support layer composed of PET fibers, which are polyester fibers, and dried at 100° C., and then subjected to heat treatment at 120° C. for one hour in a nitrogen atmosphere to form a fibrous body layer composed of liquid crystal polymer fibers.

A sound absorbing material as the sample of Example 1 was thus produced. The melting point of the liquid crystal polymer fibers is preferably controlled according to the melting point of the polyester fibers.

To evaluate the sound absorption characteristics, the sample was cut to a diameter of 41 mm, and the noise reduction coefficient (NRC) was measured using a normal incidence sound absorption coefficient measurement system (“WinZacMTX”). The NRC is the average value of the sound absorption coefficients at 250 Hz, 500 Hz, 1000 Hz, and 2000 Hz.

Fiber diameters of the fibrous body layer were measured at 30 random locations on a scanning electron microscope (SEM) image of the fibrous body layer using image processing software (“ImageJ”), and the fiber diameter of the fibrous body layer was calculated as the average value of the measured fiber diameters. The fiber diameter of the support layer was determined in the same manner.

The fiber densities of the fibrous body layer and the support layer were calculated from measurements of the weight, area and thickness of each layer of the sample used to measure the sound absorption coefficient.

The average pore diameters of the fibrous body layer and the support layer were measured using a mercury porosimeter. In particular, the average pore diameter of each layer was determined by measuring the pore distribution using a mercury intrusion porosimeter (manufactured by Micrometrics Instrument Corporation, AutoPore V 9605).

### Example 2

A sound absorbing material as the sample of Example 2 was produced in the same manner as in Example 1 except that the heat treatment temperature was changed to 140° C.

### Example 3

A sound absorbing material as the sample of Example 3 was produced in the same manner as in Example 1 except that the heat treatment temperature was changed to 160° C.

### Example 4

A sound absorbing material as the sample of Example 4 was produced in the same manner as in Example 1 except that the high-pressure dispersion treatments was performed twice to obtain liquid crystal polymer fibers (fiber diameter 2 μm), and that the heat treatment temperature was changed to 140° C.

### Example 5

A sound absorbing material as the sample of Example 5 was produced in the same manner as in Example 1 except that the high-pressure dispersion treatments was performed thirty times to obtain liquid crystal polymer fibers (fiber diameter 0.7 μm), and that the heat treatment temperature was changed to 140° C.

### Example 6

A sound absorbing material as the sample of Example 6 was produced in the same manner as in Example 1 except that the high-pressure dispersion treatments was performed thirty times to obtain liquid crystal polymer fibers (fiber diameter 0.7 μm), and that the heat treatment temperature was changed to 120° C.

### Example 7

A sound absorbing material as the sample of Example 7 was produced in the same manner as in Example 1 except that no support layer was used, and that an LCP fiber mat was produced from a slurry of liquid crystal polymer fibers using a suction filtration device and a polyester microfiber nonwoven fabric (basis weight: 14 g/m²).

### Example 8

A sound absorbing material as the sample of Example 8 was produced in the same manner as in Example 7 except that the heat treatment temperature was changed to 140° C.

### Example 9

A sound absorbing material as the sample of Example 9 was produced in the same manner as in Example 7 except that the heat treatment temperature was changed to 160° C.

### Example 10

A sound absorbing material as the sample of Example 10 was produced in the same manner as in Example 7 except that the high-pressure dispersion treatments was performed twice to obtain liquid crystal polymer fibers (fiber diameter 2 μm), and that the heat treatment temperature was changed to 140° C.

### Example 11

A sound absorbing material as the sample of Example 11 was produced in the same manner as in Example 7 except that the high-pressure dispersion treatments was performed thirty times to obtain liquid crystal polymer fibers (fiber diameter 0.7 μm), and that the heat treatment temperature was changed to 140° C.

### Example 12

A sound absorbing material as the sample of Example 12 was produced in the same manner as in Example 7 except that the high-pressure dispersion treatments was performed thirty times to obtain liquid crystal polymer fibers (fiber diameter 0.7 μm), and that the heat treatment temperature was changed to 120° C.

### Example 13

A sound absorbing material as the sample of Example 13 was produced in the same manner as in Example 1 except that after the application of the paste to one surface of the support layer and the subsequent drying of the paste, the same paste was applied to the other surface of the support layer, followed by drying of the paste.

### Example 14

A sound absorbing material as the sample of Example 14 was produced in the same manner as in Example 13 except that the heat treatment temperature was changed to 140° C.

### Example 15

A sound absorbing material as the sample of Example 15 was produced in the same manner as in Example 13 except that the heat treatment temperature was changed to 160° C.

### Example 16

A sound absorbing material as the sample of Example 16 was produced in the same manner as in Example 13 except that the high-pressure dispersion treatments was performed twice to obtain liquid crystal polymer fibers (fiber diameter 2 μm), and that the heat treatment temperature was changed to 140° C.

### Example 17

A sound absorbing material as the sample of Example 17 was produced in the same manner as in Example 13 except that the high-pressure dispersion treatments was performed thirty times to obtain liquid crystal polymer fibers (fiber diameter 0.7 μm), and that the heat treatment temperature was changed to 140° C.

### Example 18

A sound absorbing material as the sample of Example 18 was produced in the same manner as in Example 13 except that the high-pressure dispersion treatments was performed thirty times to obtain liquid crystal polymer fibers (fiber diameter 0.7 μm), and that the heat treatment temperature was changed to 120° C.

### Example 19

The sample of Example 19 was produced in the same manner as in Example 1 except that the sample of Example 3 was used as the support layer.

### Comparative Example 1

A sound absorbing material as the sample of Comparative Example 1 was produced in the same manner as in Example 1 except that the heat treatment temperature was changed to 170° C.

### Comparative Example 2

The sample of Comparative Example 2, which is a sound absorbing material, was formed solely of the polyester fibers described in Example 1.

### Comparative Example 3

A sound absorbing material as the sample of Comparative Example 3 was produced in the same manner as in Example 7 except that the high-pressure dispersion treatments was performed once to obtain liquid crystal polymer fibers (fiber diameter 2.6 μm), and that the heat treatment temperature was changed to 120° C.

The evaluation results for Examples 1 to 19 and Comparative Examples 1 to 3 are shown in Table 1 below.

TABLE 1

| | Layer structure | | |
|---|---|---|---|
| | 1st layer | 2nd layer | 3rd layer |
| Example 1 | Liquid crystal polymer | Polyester fibers | — |
| | fibers | | |
| Example 2 | Liquid crystal polymer | Polyester fibers | — |
| | fibers | | |
| Example 3 | Liquid crystal polymer | Polyester fibers | — |
| | fibers | | |
| Example 4 | Liquid crystal polymer | Polyester fibers | — |
| | fibers | | |
| Example 5 | Liquid crystal polymer | Polyester fibers | — |
| | fibers | | |
| Example 6 | Liquid crystal polymer | Polyester fibers | — |
| | fibers | | |
| Example 7 | Liquid crystal polymer | — | — |
| | fibers | | |
| Example 8 | Liquid crystal polymer | — | — |
| | fibers | | |
| Example 9 | Liquid crystal polymer | — | — |
| | fibers | | |
| Example 10 | Liquid crystal polymer | — | — |
| | fibers | | |
| Example 11 | Liquid crystal polymer | — | — |
| | fibers | | |
| Example 12 | Liquid crystal polymer | — | — |
| | fibers | | |
| Example 13 | Liquid crystal polymer | Polyester fibers | Liquid crystal polymer |
| | fibers | | fibers |
| Example 14 | Liquid crystal polymer | Polyester fibers | Liquid crystal polymer |
| | fibers | | fibers |
| Example 15 | Liquid crystal polymer | Polyester fibers | Liquid crystal polymer |
| | fibers | | fibers |
| Example 16 | Liquid crystal polymer | Polyester fibers | Liquid crystal polymer |
| | fibers | | fibers |
| Example 17 | Liquid crystal polymer | Polyester fibers | Liquid crystal polymer |
| | fibers | | fibers |
| Example 18 | Liquid crystal polymer | Polyester fibers | Liquid crystal polymer |
| | fibers | | fibers |
| Example 19 | Liquid crystal polymer | Liquid crystal polymer fibers | Polyester fibers |
| | fibers | | |
| Comp. Example 1 | Liquid crystal polymer | Polyester fibers | — |
| | fibers | | |
| Comp. Example 2 | Polyester fibers | — | — |
| Comp. Example 3 | Liquid crystal polymer | — | — |
| | fibers | | |

| | Fiber diameter | | | Fiber density | | | Average pore | | | | |
|---|---|---|---|---|---|---|---|---|---|---|---|
| | [μm] | | | [kg/m³] | | | diameter [μm] | | | | |
| | 1st | 2nd | 3rd | 1st | 2nd | 3rd | 1st | 2nd | 3rd | Overall | NRC |
| | layer | layer | layer | layer | \|layer | layer | layer | layer | layer | thickness [mm] | [—] |
| Example 1 | 1.1 | 16.1 | — | 140 | 82 | — | 1.8 | 125.7 | — | 7 | 0.48 |
| Example 2 | 1.8 | 16.8 | — | 281 | 88 | — | 2.1 | 128.9 | — | 7 | 0.46 |
| Example 3 | 2.5 | 15.9 | — | 421 | 83 | — | 3.4 | 127.3 | — | 7 | 0.51 |
| Example 4 | 2.1 | 16.4 | — | 213 | 85 | — | 4.4 | 127.4 | — | 7 | 0.32 |
| Example 5 | 1.2 | 16.4 | — | 412 | 84 | — | 0.8 | 127.4 | — | 7 | 0.38 |
| Example 6 | 1.0 | 16.2 | — | 482 | 83 | — | 0.4 | 128.8 | — | 7 | 0.30 |
| Example 7 | 1.1 | — | — | 140 | — | — | 1.8 | — | — | 7 | 0.37 |
| Example 8 | 1.8 | — | — | 281 | — | — | 2.1 | — | — | 7 | 0.38 |
| Example 9 | 2.5 | — | — | 421 | — | — | 3.4 | — | — | 7 | 0.40 |
| Example 10 | 2.1 | — | — | 213 | — | — | 4.4 | — | — | 7 | 0.28 |
| Example 11 | 1.2 | — | — | 412 | — | — | 0.8 | — | — | 7 | 0.32 |
| Example 12 | 1.0 | — | — | 482 | — | — | 0.4 | — | — | 7 | 0.27 |
| Example 13 | 1.1 | 16.1 | 1.1 | 140 | 82 | 140 | 1.8 | 125.7 | 1.8 | 7 | 0.58 |
| Example 14 | 1.8 | 16.8 | 1.8 | 281 | 88 | 281 | 2.1 | 128.9 | 2.1 | 7 | 0.59 |
| Example 15 | 2.5 | 15.9 | 2.5 | 421 | 83 | 421 | 3.4 | 127.3 | 3.4 | 7 | 0.61 |
| Example 16 | 2.1 | 16.4 | 2.1 | 213 | 85 | 213 | 4.4 | 127.4 | 4.4 | 7 | 0.43 |
| Example 17 | 1.2 | 16.4 | 1.2 | 412 | 84 | 412 | 0.8 | 127.4 | 0.8 | 7 | 0.44 |
| Example 18 | 1.0 | 16.2 | 1.0 | 482 | 83 | 482 | 0.4 | 128.8 | 0.4 | 7 | 0.42 |
| Example 19 | 1.1 | 2.5 | 16.1 | 140 | 421 | 82 | 1.8 | 3.4 | 125.7 | 7 | 0.54 |
| Comp. Example 1 | 3.6 | 16.2 | — | 980 | 86 | — | 4.6 | 127.4 | — | 7 | 0.24 |
| Comp. Example 2 | 16.2 | — | — | 85 | — | — | 127.7 | — | — | 7 | 0.22 |
| Comp. Example 3 | 2.8 | — | — | 82 | — | — | 5.3 | — | — | 7 | 0.21 |

As can be seen in Table 1, the samples of Examples 1 to 19, which include a fibrous body layer formed of entangled liquid crystal polymer fibers and in which the fibrous body layer has a fiber diameter of not less than 1 μm and not more than 3 μm and a fiber density of 100 kg/m³ or more, are excellent in the sound absorption characteristics in the low frequency range even when the overall thickness is small.

As can be seen from comparison between Examples 1 to 3 and Examples 4 to 6, the sound absorption characteristics in the low frequency range are superior when the average pore diameter of the fibrous body layer is 4 μm or less. The comparison also indicates that the average pore diameter of the fibrous body layer is preferably 0.5 μm or more, and more preferably 1 μm or more. The same holds true for comparison between Examples 7 to 9 and Examples 10 to 12, and for comparison between Examples 13 to 15 and Examples 16 to 18.

As can be seen from comparison between Examples 1 to 6 and Examples 7 to 12, the inclusion of the support layer in addition to the fibrous body layer improves the sound absorption characteristics in the low frequency range.

As can be seen from comparison between Examples 1 to 6 and Examples 13 to 18, the sound absorption characteristics in the low frequency range are superior when the fibrous body layer is provided on each of both main surfaces of the support layer.

The date for Example 19 indicates that the sound absorption characteristics in the low frequency range are superior when two or more fibrous body layers are provided on the main surface of the support layer.

### REFERENCE SIGNS LIST

1, 2, 3 porous body
10, 10a, 10b, 10c fibrous body layer
20 support layer

1. A porous body comprising:
a fibrous body layer comprising entangled liquid crystal polymer fibers, wherein the entangled liquid crystal polymer fibers have a fiber diameter of not less than 1 μm and not more than 3 μm and the fibrous body layer has a fiber density of 100 kg/m³ or more.

2. The porous body according to claim 1, wherein the fiber density is 100 kg/m³ to 1000 kg/m³.

3. The porous body according to claim 1, wherein an average pore diameter of the fibrous body layer is 4 μm or less.

4. The porous body according to claim 3, wherein the average pore diameter of the fibrous body layer is 0.5 μm to 4 μm.

5. The porous body according to claim 3, wherein the average pore diameter of the fibrous body layer is 1 μm to 4 μm.

6. The porous body according to claim 1, further comprising a support layer comprising entangled fibers supporting the fibrous body layer.

7. The porous body according to claim 6, wherein the entangled fibers are entangled polyester fibers.

8. The porous body according to claim 6, wherein the fibrous body layer is on one main surface of the support layer.

9. The porous body according to claim 6, wherein the fibrous body layer is a first fibrous body layer and is on a first main surface of the support layer, the porous body further comprising a second fibrous body layer on a second main surface of the support layer.

10. The porous body according to claim 9, wherein the entangled liquid crystal polymer fibers are first entangled liquid crystal polymer fibers, and the second fibrous body layer comprises second entangled liquid crystal polymer fibers, wherein the second entangled liquid crystal polymer fibers have a fiber diameter of not less than 1 μm and not more than 3 μm and the second fibrous body layer has a fiber density of 100 kg/m³ or more.

11. The porous body according to claim 6, wherein the fibrous body layer comprises two or more layers, and is on at least one main surface of the support layer.

12. The porous body according to claim 6, wherein a fiber diameter of the entangled fibers in the support layer is larger than the fiber diameter of the entangled liquid crystal polymer fibers in the fibrous body layer.

13. The porous body according to claim 6, wherein a fiber density of the support layer is lower than the fiber density of the fibrous body layer.

14. The porous body according to claim 6, wherein an average pore diameter of the support layer is larger than an average pore diameter of the fibrous body layer.

15. The porous body according to claim 1, wherein the porous body has an overall thickness of less than 10 mm.

16. The porous body according to claim 15, wherein the overall thickness is 1 mm to 10 mm.

17. A sound absorbing material comprising the porous body according to claim 1.
